(19) United States
(12) Patent Application Publication
(10) Pub. No.: US 2015/0023517 A1
(43) Pub. Date: Jan. 22, 2015

(54) APPARATUS FOR PROVIDING WIRELESS FUNCTIONALITY TO AN AUDIO PLAYBACK DEVICE

(71) Applicant: Mizco International Inc., Avenel, NJ (US)

(72) Inventor: Maurice Mizrahi, Brooklyn, NY (US)

(21) Appl. No.: 14/338,130

(22) Filed: Jul. 22, 2014

Related U.S. Application Data
(60) Provisional application No. 61/856,826, filed on Jul. 22, 2013.

(51) Int. Cl. H04R 1/10

(52) U.S. Cl. CPC H04R 1/1075; H04R 1/1091; H04R 2201/103; H04R 2201/109
USPC 381/74

(57) ABSTRACT

A wireless module for providing wireless transmission of audio to an audio playback apparatus, such as a set of headphones or speakers, is provided. The wireless module may include a wireless transceiver configured for receiving an audio stream, an audio output interface configured for sending an audio output stream, and a fastener for fastening the wireless transceiver to the audio playback apparatus. The fastener may be a spring loaded grasping fastener, a magnetic or sticky fastener, a clamping fastener or a clip fastener.

### CLAIM OF PRIORITY

The present Application for Patent claims priority to U.S. Provisional Application No. 61/856,826 entitled “Apparatus for Providing Wireless Functionality to Conventional Headphones”, filed Jul. 22, 2013, which is hereby expressly incorporated by reference.

### TECHNICAL FIELD

The present disclosure relates generally to wireless communication, and more particularly, to wireless streaming audio.

### BACKGROUND

With the proliferation of various audio formats in recent years, users are increasingly relying on portable devices so they can allow users to enjoy music at convenient locations. Despite the portability offered by these devices, the operation of the devices is not always convenient. One major drawback of these devices is the necessity for a user's headphones to be connected or plugged into the device. Typically, in order for a user to listen to music from such a device, the user must wear headphones that are physically connected to the device. Such a configuration is not always ideal. For example, if a user is engaged in sporting activities, the physical connection of the headphones to the device may limit the user's mobility. Moreover, the possible jostling of the headphones during such activities may cause ear cups of the headphones to be dislodged from the user's ears, or cause the headphones to become disconnected from the device. In either case, the user may experience an undesirable interruption.

Another drawback of certain such devices is the need for a user to physically manipulate control buttons on the device in order to control the audio playback. Unfortunately, the need for the user to physically manipulate the controls requires the user to keep the device in relatively close proximity

Consequently, in view of the above, there is a need for providing wireless functionality to a set of headphones or other audio playback devices.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates a wireless module for providing wireless functionality to an audio playback device.

FIG. 2 illustrates an exploded view of the wireless module of FIG. 1.

FIG. 3A illustrates a top view of one example of a grasping fastener configured for enabling mounting of a wireless module to an audio playback device.

FIG. 3B illustrates a bottom view of the grasping fastener of FIG. 3A.

FIG. 4 shows an exploded view of the grasping fastener of FIGS. 3A-3B of FIG. 1.

FIG. 5 illustrates a front perspective view of the wireless module of FIG. 1 mounted onto a headband of a set of headphones.

FIG. 6 illustrates a side elevation view of the wireless module mounted onto the headband of the set of headphones of FIG. 5.

FIG. 7 illustrates a grasping fastener utilized to secure a wireless module to a large sized headband.

FIG. 8 illustrates a grasping fastener utilized to secure a wireless module to a small sized headband.

FIG. 9 illustrates a metal plate for mounting a wireless module to an audio playback device using a magnetic or sticky fastener, according to one aspect.

FIG. 10 illustrates the wireless module mounted to an ear cup of a set of headphones using the metal plate of FIG. 9.

FIG. 11 illustrates a metal plate for mounting a wireless module using a magnetic or sticky fastener, according to a second aspect.

FIG. 12 illustrates a cross sectional view of one example of a clamping fastener configured for enabling mounting of a wireless module onto a large sized headband of a set of headphones.

FIG. 13 illustrates a cross sectional view of one example of a clamping fastener configured for enabling mounting of a wireless module onto a small sized headband of a set of headphones.

FIG. 14 illustrates a modular clamping fastener adapted to receive different size claws.

FIG. 15 illustrates a wireless module mounted onto a large sized headband of a set of headphones.

FIG. 16 illustrates a wireless module mounted onto a small sized headband of a set of headphones.

FIG. 17 illustrates a cross sectional view of one example of a clip fastener configured for enabling mounting of the wireless module onto a small headband of set of headphones.

FIG. 18 illustrates a cross sectional view of one example of a clip fastener configured for enabling mounting of the wireless module onto a large headband of set of headphones.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

According to one aspect, an apparatus for providing wireless transmission of audio content is provided. The apparatus may include a wireless module and a fastener for fastening the wireless module to an audio playback apparatus. The wireless module may include a wireless transceiver configured for receiving an audio stream and an audio output interface configured for sending an audio output stream.

According to one feature, the fastener may comprise a spring loaded grasping fastener. The grasping fastener may comprise a grasping fastener housing having a ring located between and integrally attached to a pair of tubular members; and a grasping arm having a friction grasping member secured to one or more rods configured to be movably received into the pair of tubular members.

According to another feature, the fastener may comprise a metal plate adapted to be affixed to the audio playback device; and one or more magnets affixed to the wireless module for securing the wireless module to the audio playback device by a magnetic force. In one non-limiting example, the metal plate may include a notch. The metal plate may be a ferromagnetic metal plate.

According to yet another feature, the fastener may comprise one or more claws hingedly attached to a fastener housing configured to clamp onto the audio playback device.

According to yet another feature, the fastener may comprise one or more clips secured to a fastener housing and configured to flex and clip onto the audio playback device.

According to yet another feature, the wireless module may further include a bottom panel having an outer surface and an opposing inner surface, the wireless transceiver secured to the inner surface of the bottom panel; an internal panel, in electrical communication with the wireless transceiver, the audio output interface secured to the internal panel; and a housing adapted to receive the internal panel and the bottom panel, the bottom panel configured to form a bottom of the housing.

According to yet another feature, the wireless module may further include a user interface, in electrical communication with the audio output interface, for enabling audio playback functionality, wherein the user interface comprises a plurality of buttons. The user interface may be located on an outer surface of the housing and may be a tactile switch.

According to yet another feature, the audio playback device may be a set of headphones.

According to another aspect, an apparatus for providing wireless transmission of audio content is provided. The apparatus may include a wireless module and a fastener for fastening the wireless module to an audio playback apparatus. The wireless module may include a bottom panel having an outer surface and an opposing inner surface; a wireless transceiver, secured to the inner surface of the bottom panel, configured for receiving an audio stream; an internal panel, in electrical communication with the wireless transceiver, having an audio output interface configured for sending an audio output stream; a housing adapted to receive the internal panel and the bottom panel, the bottom panel configured to form a bottom of the housing; and a fastener for fastening the housing of the wireless module to an audio playback apparatus.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. In the context of the present specification, when an element is referred to as being “on” another element, it can be directly on the other element or be indirectly on the other element with one or more intervening elements interposed therebetween. Also, in the context of the present specification, when an element is referred to as being “connected” or “coupled” to another element, it can be directly connected or coupled to the other element or be indirectly connected or coupled to the other element with one or more intervening elements interposed therebetween. Like reference numerals designate like elements throughout the specification.

In the following description, certain terminology is used to describe certain features of one or more embodiments. The term “audio playback apparatus” may refer to any type of output device configured to transmit audio information to one or more speakers, e.g., in a set of headphones, in a car, or any other desired destination of the audio information. The term “hole” may refer to any opening through a structure and/or component or a hollowed-out place in a structure and/or component, including apertures, bores, cavities, chambers, grooves, notches, passages, slits and slots. The term “protrusion” may refer to objects or parts projecting in an outward or upward manner from a structure and/or component.

### Overview

One or more embodiments of the present disclosure are directed to wireless modules (or wireless transceivers) for providing wireless transmission of audio content to an audio playback apparatus, such as a set of headphones or speakers. The wireless module may include a wireless transceiver configured for receiving an audio stream, an audio output interface configured for sending an audio output stream and a fastener for fastening the wireless transceiver to the audio playback apparatus. According to one aspect, the fastener may be a spring loaded grasping arm for grasping a headband of a set of headphones. According to another aspect, the fastener may include a metal plate affixed to an ear cup of a set of headphones and one or more magnets affixed to the wireless transceiver for securing the wireless transceiver to the ear cup by a magnetic force. According to yet another aspect, the fastener may be one or more claws attached to a housing utilizing a spring-loaded hinge, configured to clamp onto a headband of a set of headphones. According to yet another aspect, the fastener may be one or more clips configured to flex and clip onto a headband of a set of headphones.

### Wireless Module

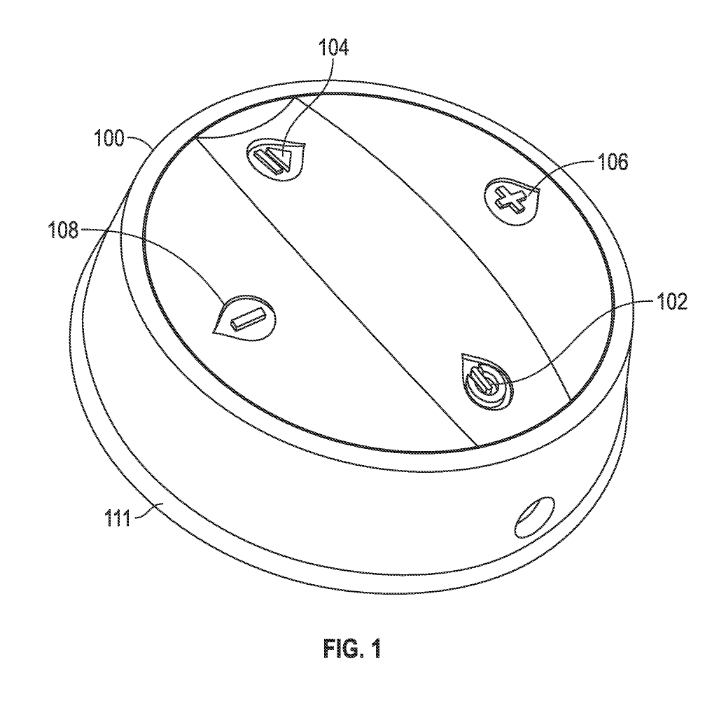

FIG. 1 illustrates a wireless module 100 for securing to an audio playback device. In various examples within the scope of the present disclosure, the wireless module 100 (or wireless transceiver) may be configured in accordance with one or more suitable wireless communication protocols, including but not limited to wireless wide area network (WWAN) communication protocols or wireless personal area network (WPAN) communication protocols. As one non-limiting example, the wireless module 100 may be configured according to Bluetooth communication protocols, e.g., as defined by the Bluetooth Special Interest Group, whose standards are publically available. In the disclosure that follows, the wireless module 100 may be referred to as a Bluetooth module 100. However, those of ordinary skill in the art will comprehend that this nomenclature is merely for convenience, and within the scope of the present disclosure, the wireless module 100 may utilize any suitable wireless communication protocol.

In one example, the wireless module 100 (or wireless transceiver) may include a Bluetooth transceiver circuit configured to receive a wireless transmission, e.g., including audio information, from one or more external Bluetooth transceiver circuits (not illustrated). As one non-limiting example, a personal computer that includes a Bluetooth transceiver may be configured to stream audio data, stored in its hard drive, to the wireless or Bluetooth module 100, such that the wireless module 100 may receive and enable playback of the audio stream as described below. Of course, any source of a wireless stream may be utilized within the scope of the present disclosure.

As shown in FIG. 1, the wireless module 100 (or wireless transceiver) may include a user interface, such as a plurality of control buttons or switches, for enabling various functionality generally desired for audio playback including, but not limited to, a power button 102, a play/pause button 104, a forward/next track button 106, and a reverse/previous track button 108. According to one example, a user may manually depress the buttons and/or switches for operation of their respective functions. Of course, this is merely one example for illustrative purposes, and any suitable user interface (or no user interface) may be included on a particular implementation within the scope of the present disclosure. In an example where the user interface is included, use of the user interface may cause the Bluetooth transceiver within the wireless or Bluetooth module 100 to transmit control information to the external Bluetooth transceiver circuit (not illustrated) (e.g., the source of the audio data stream), to enable control of the playback of the audio stream. Additionally, the plurality of buttons and/or switches may be used as tactile reference markers to assist the user with proper alignment of the wireless module 100 when mounting the wireless module to a set of headphones or other the audio playback device.

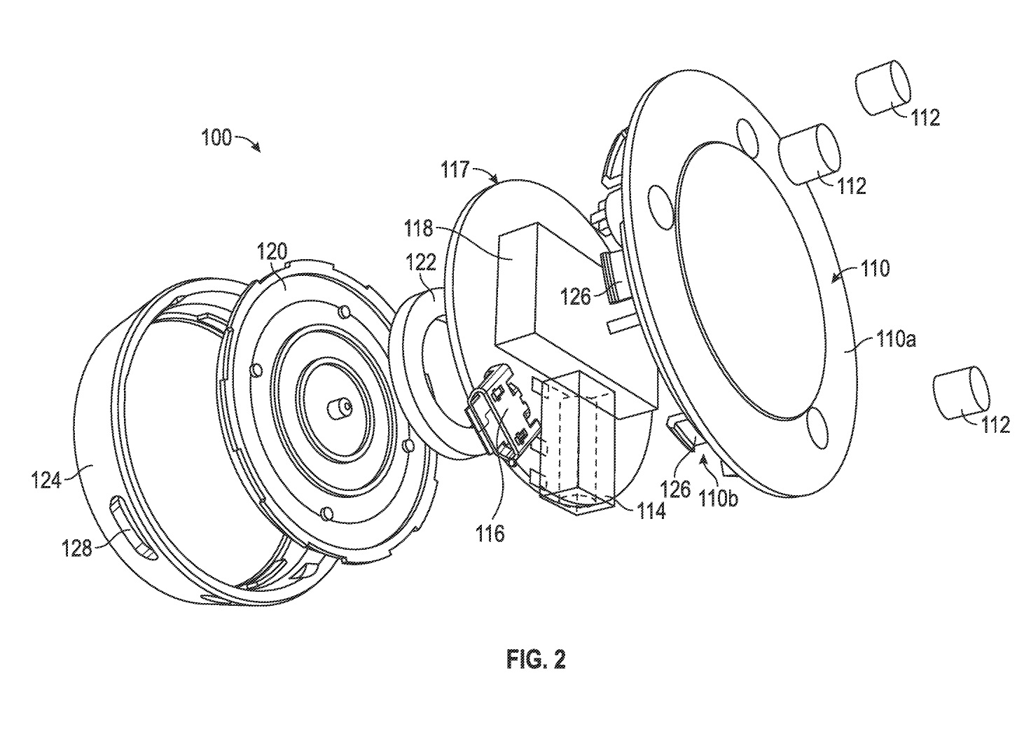

FIG. 2 illustrates an exploded view of the wireless module 100 (or wireless transceiver) of FIG. 1. As shown, the wireless module 100 may include a bottom panel 110, having an outer surface 110a and an opposing inner surface 110b. According to one example, the bottom panel 110 may have a generally circular configuration and one or more magnets 112 located around the perimeter of the bottom panel 110, as described in further detail below, for retaining the wireless module 100 to an audio playback device, such as a set of headphones. A circuit board, having wireless circuitry, may be located on the inner surface 110b of the bottom panel 110. The circuit board may be in electrical communication with an audio cable interface 114 and a data/charging interface 116 located on an internal panel 117 which may also have a generally circular configuration. In one example, the audio cable interface 114 may be configured to accept a standard 3.5 mm stereo headphone jack, although any suitable interface for enabling the connection of any size or configuration of audio cable (or no audio cable interface) may be included in a particular implementation. When a female 3.5 mm stereo headphone interface is included, a user may be enabled to plug a male 3.5 mm headphone jack into the audio cable interface 114.

In some examples, the audio cable interface 114 may provide an audio output signal, which may or may not be amplified internal to the wireless module 100. Here, the audio cable interface 114 may be enabled to electrically couple the wireless module 100 to an output device (not illustrated), to transmit audio information to one or more speakers, e.g., in a set of headphones, in a car, or any other desired destination of the audio information.

In one example, the data/charging interface 116 may be configured to accept a standard micro-USB or mini-USB jack, although any suitable interface for enabling the connection of any size or configuration data/charging cable (or no data/charging interface) may be included in a particular implementation. When a micro-USB data/charging interface 116 is included, a user may be enabled to plug a male micro-USB jack into the data/charging interface 116 to provide power to charge a battery 118 internal to the wireless module 100, to provide active power for operation of the wireless module 100, and/or for single-direction or bi-directional data communication with the wireless module 100.

In one example, the wireless module 100 may include a switch 120, such as a tactile switch, for controlling and/or operating the power button 102, play/pause button 104, forward/next track button 106 and the reverse/previous track button 108 of the user interface. In one non-limiting example, the switch 120 may be a tactile switch 120; however any type of switch known in the art may be utilized within the scope of the present disclosure. A foam ring 122, having a generally circular configuration, may be located between the tactile switch 120 and the internal panel 117 to provide cushioning when a user depressing any of the buttons on the user interface, i.e. the power button 102, play/pause button 104, forward/next track button 106 and/or the reverse/previous track button 108. An outer ring or housing 124 may be placed over the tactile switch 120, the foam ring 122 and the internal panel 117 and secured to the bottom panel 110.

According to one embodiment, one or more protrusions 126 may extend perpendicularly outward from the inner surface 110b of the bottom panel 110 and adapted to be received or inserted into one or more corresponding holes 128 in the outer ring/housing 124 securing the outer ring/housing 124 to the bottom panel 110. Furthermore, the bottom panel 110 may have a diameter larger than the diameter of the outer ring/housing 124 forming a flange 111 on the bottom panel 110 which may be utilized to secure a grasping fastener 200 to an audio playback device, as described in further detail below.

According to some aspects of the present disclosure, the wireless module 100 may be configured to be mounted onto audio playback, including but not limited to a set of headphones, a car stereo including an “AUX” (auxiliary) media input jack, a home stereo including a media input, or any other suitable apparatus for audio playback.

### Grasping Fastener

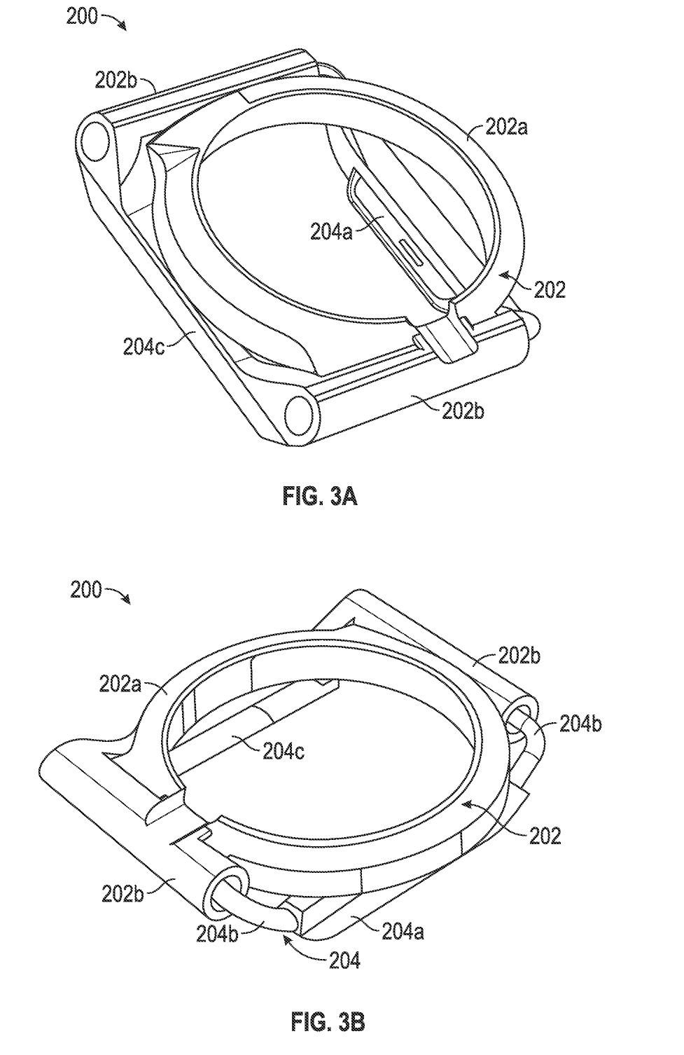

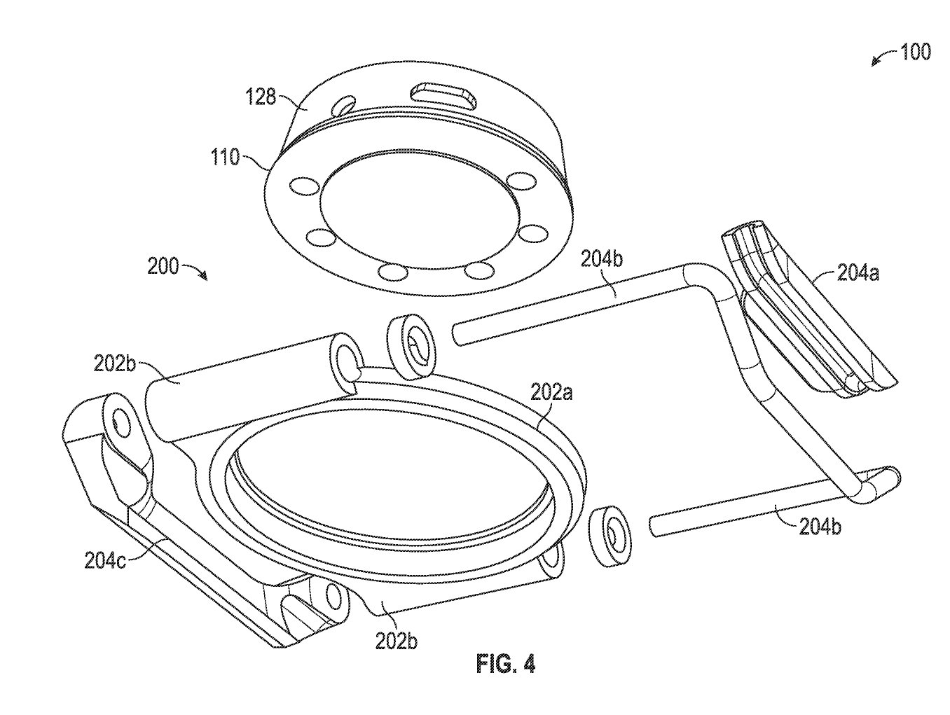

As one example, the wireless module 100 (or wireless transceiver) may be configured to utilize a grasping fastener 200 for mounting the wireless module to the audio playback device. FIGS. 3A and 3B illustrate a top view and a bottom view, respectively, of one example of a grasping fastener 200 configured for enabling mounting of a wireless module to an audio playback device, such as a set of headphones, as described below. FIG. 4 shows an exploded view of the grasping fastener 200 of FIGS. 3A-3B next to the wireless module of FIG. 1.

In various examples within the scope of the present disclosure, the grasping fastener 200 may include a grasping fastener housing 202 for generally securing the wireless module 100, and a grasping arm 204 for securing the combined wireless module 100 and grasping fastener 200 to the audio playback device, such as a set of headphones.

The grasping fastener housing 202 may include a ring 202a located between and integrally attached to a pair of tubular members 202b. The grasping arm 204 may include a friction grasping member 204a for contacting with and grasping onto the headband of a set of headphones, and one or more rods 204b configured to be received into the corresponding tubes 202b in the grasping fastener housing 202. In some examples, the grasping fastener 200 may further include one or more springs (not illustrated) within the tubes in pair of tubular members 202b, configured to exert a pulling force on the rods 204b, to enable the user to pull the grasping arm 204 out from the housing, but to pull the grasping arm 204 back towards the grasping fastener housing 202 to provide a grasping force onto the headband of the set of headphones. Here, the housing 202 may additionally include a wall 204c opposite the grasping arm 204 to provide an opposing surface, such that the grasping force provided by the springs to the grasping arm 204 may be met with an opposing grasping force to secure the wireless module 100 to the headphones.

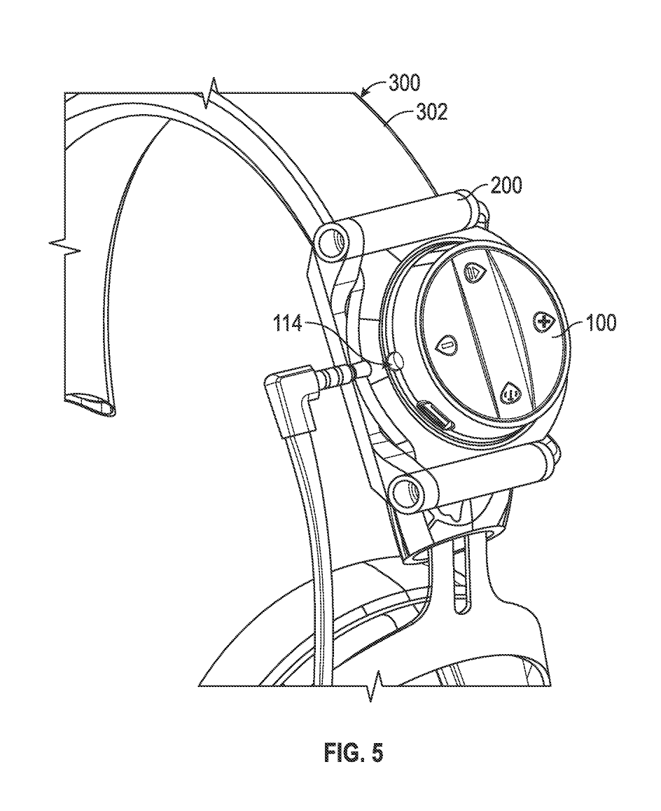

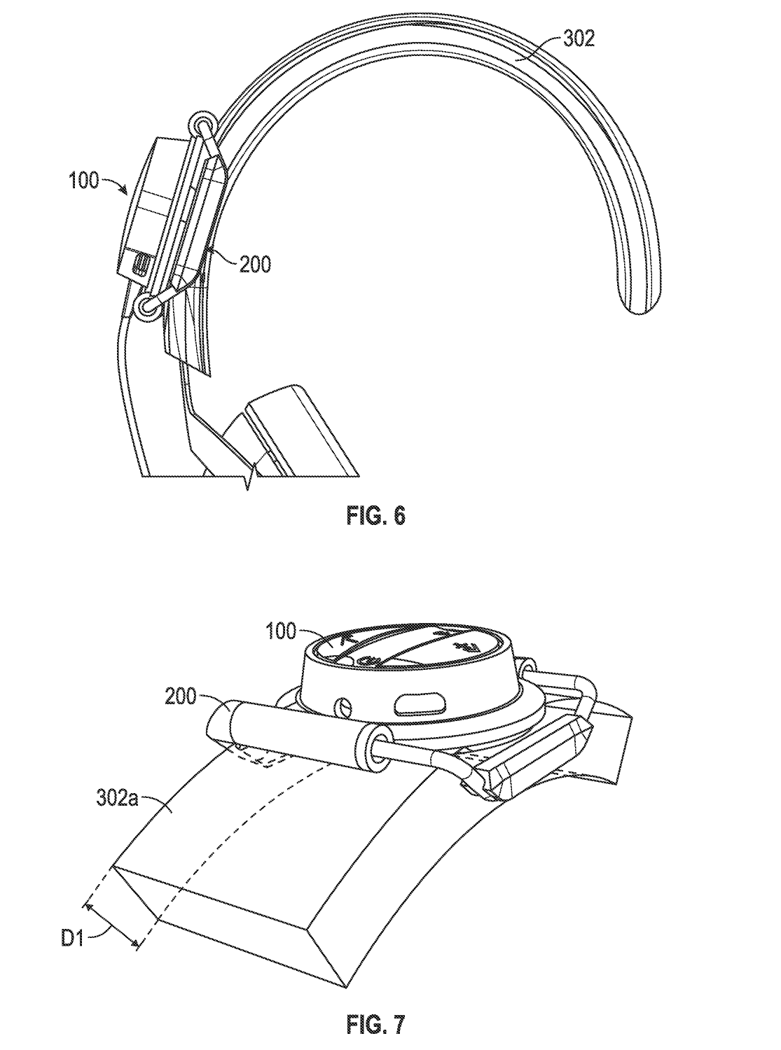

FIG. 5 illustrates a front perspective view of the wireless module 100 of FIG. 1 mounted onto a headband 302 of a set of headphones 300 utilizing the grasping fastener 200 as described above. FIG. 6 illustrates a side elevation view of the wireless module 100 mounted onto the headband of the set of headphones of FIG. 5. In an aspect of the present disclosure, the grasping fastener 200 may be configured to mount onto more than one size headband. That is, the grasping arm 204 may be configured, e.g., by way of the springs exerting a grasping force even if the grasping arm 204 is within a range of positions, to enable grasping of headbands having a range of sizes. Furthermore, the friction grasping member 204a and the wall opposite 204c the grasping arm 204 may include relatively high-friction surfaces, and/or suitable shape, to enable effective grasping of a headband of various width, thickness, texture, and material.

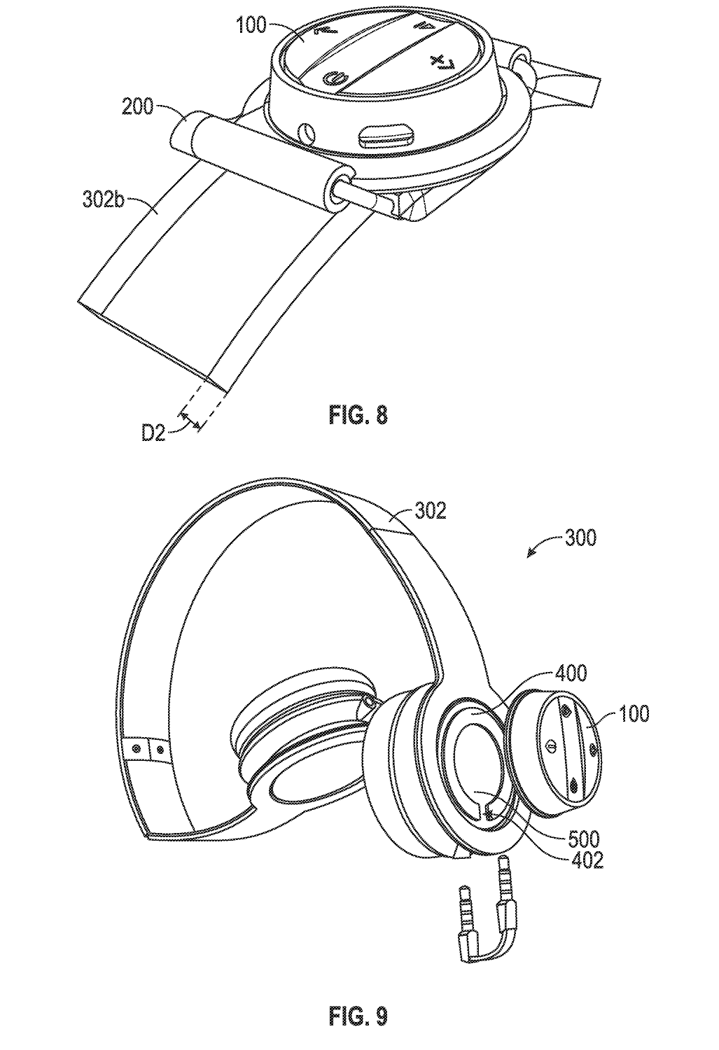

For example, FIG. 7 illustrates a grasping fastener 200 utilized to secure a wireless module 100 to a large sized headband 302a, and FIG. 8 illustrates a grasping fastener 200 utilized to secure a wireless module 100 to a small sized headband 302b. As shown, the large headband 302a may have a thickness D1 and the small headband has a thickness D2, where D2 is less than D1 (i.e. D2<D1). Those of ordinary skill in the art will recognize that these two sizes or thicknesses of headbands 300 are merely illustrative in nature, and a grasping fastener 200 within the scope of the present disclosure may be enabled to grasp a large range of headband sizes (or thicknesses) not limited to the sizes of the large headband 302a and the small headband 302b.

In the illustrated examples, the wireless module 100 may be secured to the grasping fastener 200 by means of the flange 111 extending around a circumference of an outer surface 110a of the bottom panel 110 of the wireless module 100, as seen in FIG. 1. Also, as seen in FIG. 2 and described above, the flange 111 may be provided in some examples by a bottom panel 110 of the wireless module 100 having a larger radius than that of an outer rim of the housing 124 of the wireless module 100. In this way, when the wireless module 100 is passed through a bottom of the ring 202a of the grasping fastener housing 202 of the grasping fastener 200, the flange 111 may act as a stop, such that the wireless module 100 does not pass completely through the ring 202a. In some examples, the wireless module 100 may be configured to remain secure within the grasping fastener 200 by being mounted, e.g., onto the headband 300 of the headphones. That is, in this example, when the wireless module 100 is within the ring 202a of the grasping fastener housing 202 of the grasping fastener 200, the flange 111 on the wireless module 100 may stop the wireless module 100 from passing completely through the ring 202a and out of the grasping fastener 200, while the surface of the headband 300 presses against the bottom of the wireless module 100, keeping the wireless module 100 secure within the grasping fastener 200.

Of course, the use of the flange 111 stop opposed to support from a headband 300 or other surface underneath the wireless module 100, is not limited to the example described above utilizing the grasping fastener 200. That is, this mechanism may be utilized to secure the wireless module 100 within any suitable fastener, housing, or other apparatus.

### Magnetic or Sticky Fastener

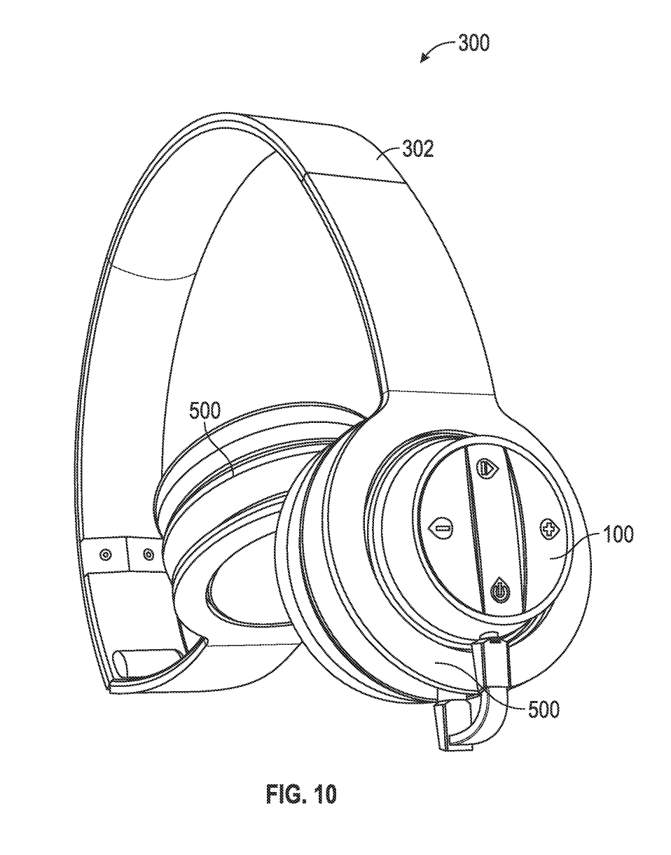

As another example, the wireless module 100 may be configured to utilize a magnetic or sticky fastener 400 for mounting the wireless module 100. Utilizing the metal plate 400 allows a user to mount or remove the wireless module 100 easily. FIGS. 9 and 10 illustrate one example of using a magnetic or sticky fastener to mount a metal plate 400 according to an aspect of the disclosure. In the illustrated example, the metal plate 400 (e.g., a ferromagnetic metal, e.g., steel) may be generally ring-shaped and may be fastened to the ear cup 500 of a set of headphones by utilizing any suitable means, e.g., two-sided tape, glue, adhesive, one or more screws, etc. By utilizing the metal plate 400, the wireless module 100 may be fastened to the ear cup 500 of the set of headphones by means of one or more magnets 112.

For example, as seen in FIG. 2, the outer surface 110a of the bottom panel 100 of the wireless module 100 as illustrated includes three (3) cylindrically shaped magnets 112, such are rare earth magnets. Of course, the inclusion of the magnets in the wireless module 100 is optional, and may or may not be included in a particular implementation. However, in the illustrated example of FIG. 2, the three (3) magnets 112 may be contained mostly or entirely internal to the wireless module 100, such that the wireless module 100 may be fastened utilizing any suitable fastener, including but not limited to the magnetic fastener 400 described herein. Although three (3) magnets 112 are shown, this is by way of example only and more than three (3) magnets or less than three (3) magnets may be utilized.

Returning to FIGS. 9 and 10, it can be seen that the wireless module 100 as illustrated may be easily fastened to the ear cup 500 by placing the wireless module 100 onto the metal plate 400, such that the magnets 112 secure the wireless module 100 onto the metal plate.

In the illustration of FIG. 9, the metal plate of the magnetic fastener 400 is largely ring shaped, but includes a notch or opening 402. This notch 402 is optional, and may be included for alignment of the wireless module 100, for making space for a feature on the bottom of the wireless module 100, or for any other suitable purpose.

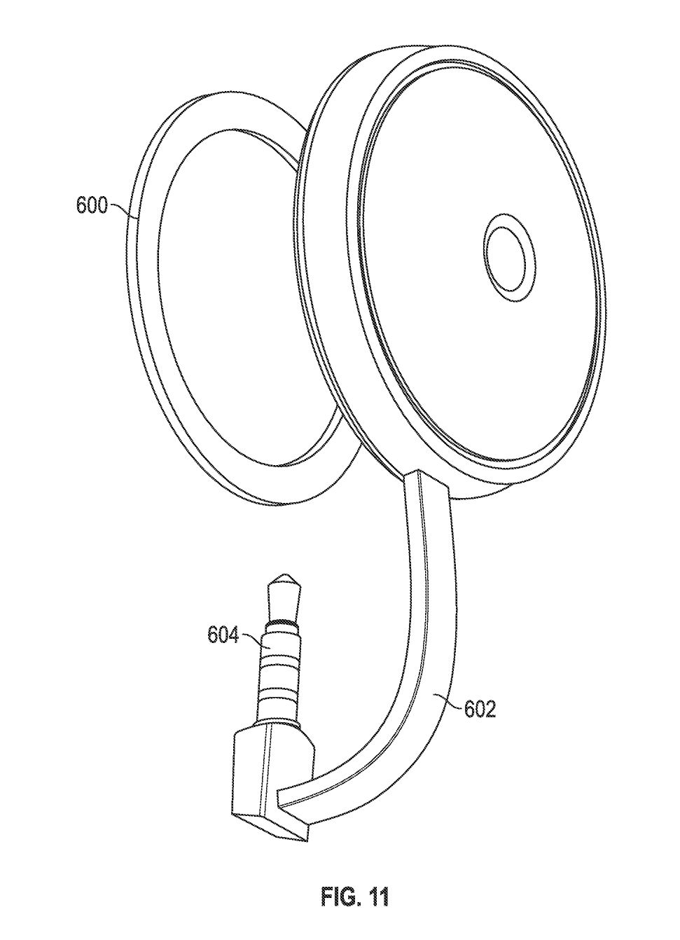

FIG. 11 illustrates another example of a metal plate 600 mounted to an ear cup of a set of headphones using a magnetic or sticky fastener, this example not including the notch described above. Furthermore, as seen in FIG. 11, the wireless module 100, while it may function in the same or a similar way, has a modified appearance and includes a hard-wired audio connector cable 602 with a male audio jack 604, rather than the female audio interface described above. Those of ordinary skill in the art will comprehend that, as described herein, the wireless module 100 may take the illustrated configurations or other configurations within the scope of the present disclosure.

Clamping Fastener

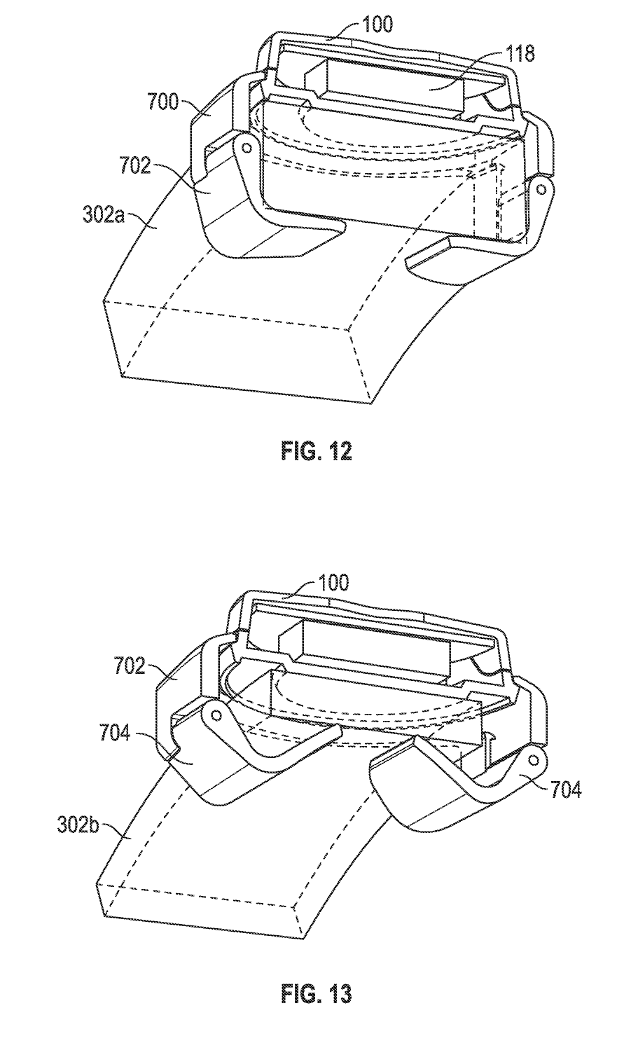

As another example, the wireless module 100 may be configured to utilize a clamping fastener 700 for mounting the wireless module 100. FIGS. 12 and 13 illustrate cross sectional views of one example of a clamping fastener 700 configured for enabling mounting of the wireless module 100 to large and small sized headbands 302a, 302b, respectively, of a set of headphones, as described below, according to an aspect of the disclosure.

In various examples within the scope of the present disclosure, the clamping fastener 700 may include a housing (e.g., a ring) 702 that secures the wireless module 100 to the headband in the same or a similar way as described above for the grasping fastener 200.

As illustrated, the clamping fastener 700 includes a plurality of claws 704 for clamping onto an apparatus, such as a headband 300 of a set of headphones. Here, the claws 704 may be secured onto the housing 702 of the clamping fastener 700 by hinges 706, which enable the claws 704 to operate between an open position and a closed position. In this way, the headband 300 may be inserted between the claws 704 in an open position. Further, the hinges 706 may include springs (not illustrated), such that once the headband 300 is inserted into the claws 704, the claws 704 may retract into the closed position in such a way as to clamp onto the headband 300. In this way, the clamping fastener 700 may hold the wireless module 100 onto the headband 300 by a friction fit, wherein the claws 704 grasp onto or around the headband 300. According to one aspect, the claws 704 may have a generally L-shaped configuration.

The spring-loaded hinges may be configured to enable a clamping force at a range of positions, enabling clamping onto a range of sizes of headband 300. For example, FIG. 12 illustrates a clamping fastener 700 mounting a wireless module 100 onto a large sized headband 302, while FIG. 13 illustrates a clamping fastener 700 mounting a wireless module 100 onto a small sized headband 304. Those of ordinary skill in the art will recognize that these two sizes of headbands are merely illustrative in nature, and a clamping fastener 700 within the scope of the present disclosure may be enabled to grasp a large range of headband sizes not limited to the sizes of the large headband 302 and the small headband 304.

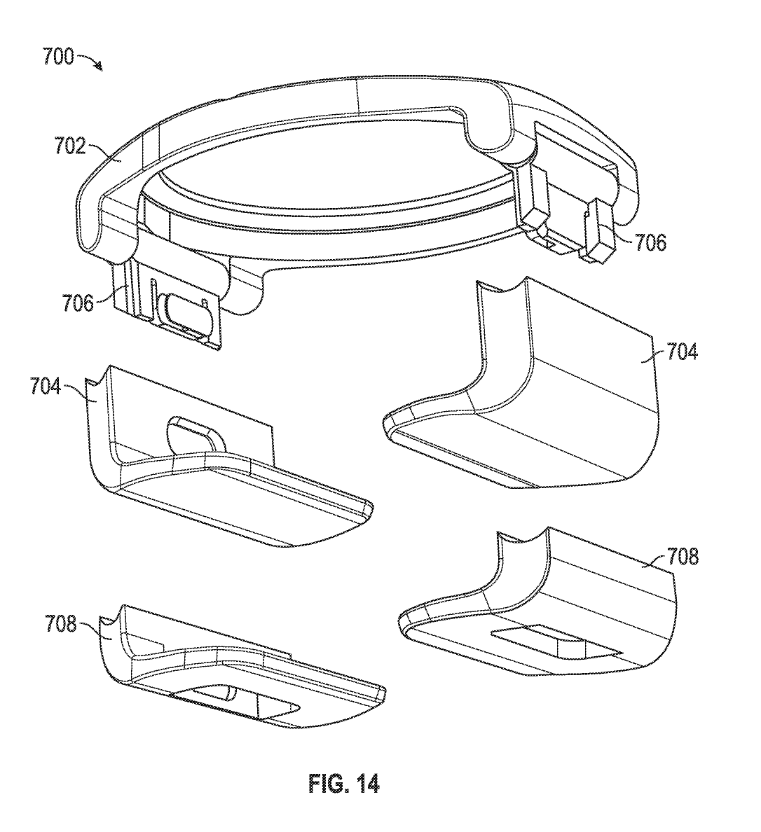

FIG. 14 illustrates a further aspect of the disclosure, wherein the clamping fastener 700 may be modular in nature, such that different sizes of claws may be utilized for fastening the wireless module 100 to a wider range of sizes of headband 300. In some examples, the claws can easily be removed and attached by a user, such that two or more sizes of claws (e.g., large claws 704 and small claws 708) may be provided with the clamping fastener 700. For example, the large claws 704 may be configured to snap onto the hinges 706 of the clamping fastener 700. Alternatively, the small claws 708 may be configured to snap onto the hinges 706 of the clamping fastener 700.

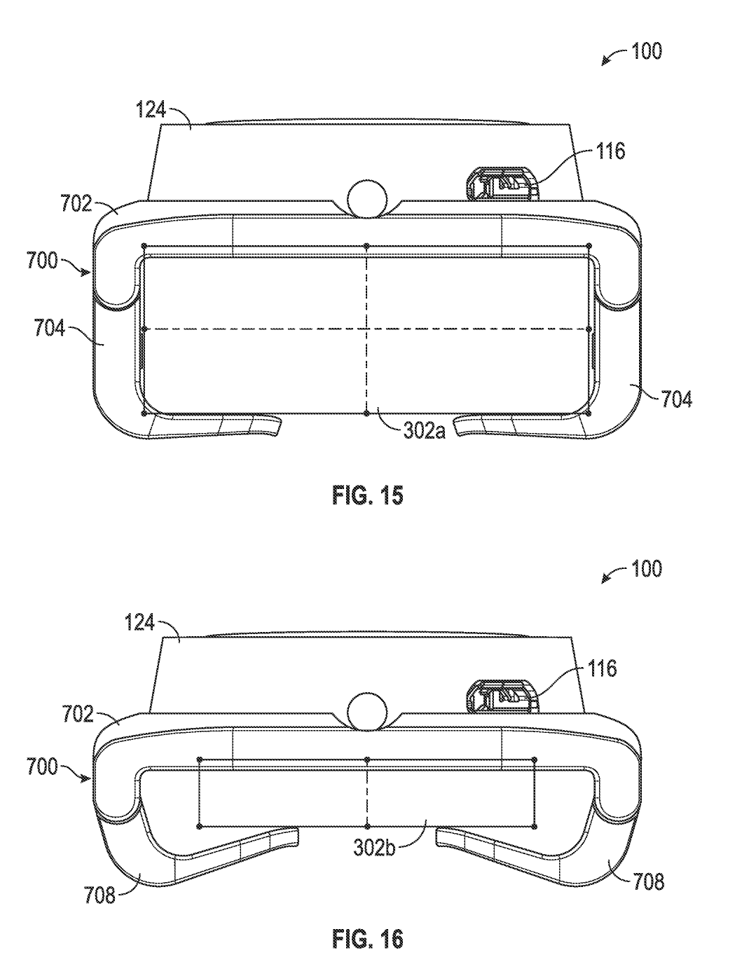

FIGS. 15 and 16 are further illustrations showing how different sizes of claws (e.g., the large claws 704 and the small claws 708) may enable the wireless module 100 to be secured to a wide range of sizes of headbands 300. Of course, the exact dimensions of the claws are not limited to those illustrated, and within the scope of the present disclosure, any suitable size claws may be included, and any number of different-sized claws may be provided to enable securement of the wireless module 100 to any size headband, such as a large sized headband 302a or a small sized headband 302b, or other apparatus.

### Clip Fastener

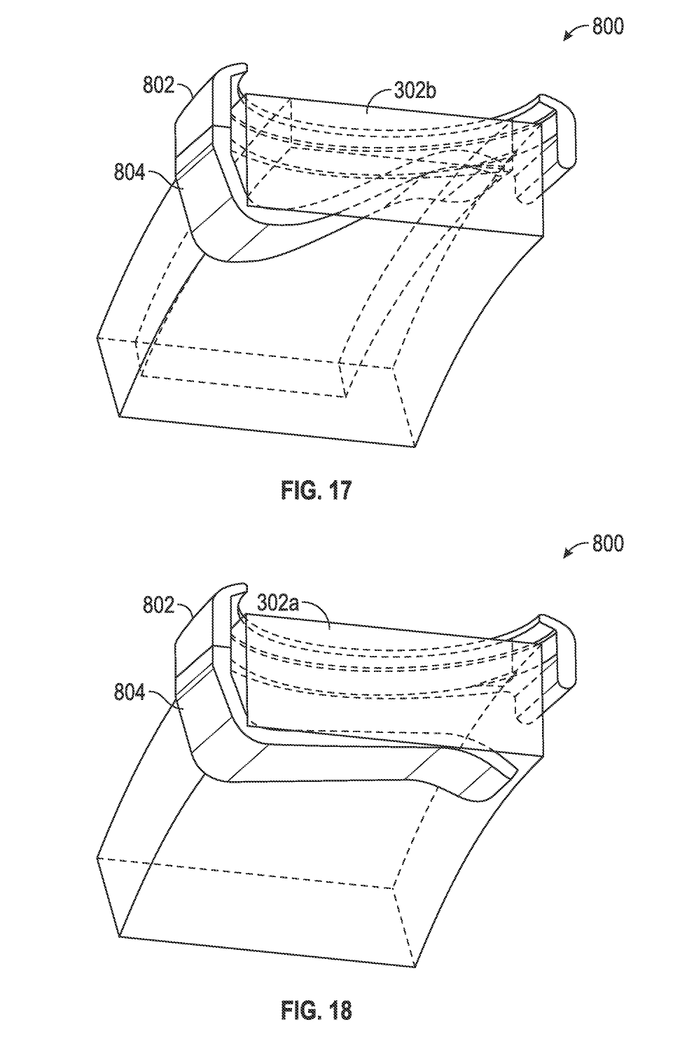

As another example, the wireless module 100 may be configured to utilize a clip fastener 800 for mounting the wireless module. FIGS. 17 and 18 illustrate cross sectional views of one example of a clip fastener 800 configured for enabling mounting of the wireless module 100 to large and small sized headbands 302a, 302b, respectively, of a set of headphones, as described below, according to an aspect of the disclosure.

In various examples within the scope of the present disclosure, the clip fastener 800 may include a housing 802 (e.g., a ring) that secures the wireless module 100 to the headband in the same or a similar way as described above for the grasping fastener 200.

As illustrated, the housing 802 of the clip fastener 802 may include a clip 804 for clipping onto an apparatus, such as a headband 300 of a set of headphones. Here, the clip 804 may be secured onto the housing 802 of the clip fastener 800 utilizing any suitable securement mechanism. In the illustrated clip fastener 800, the clip 804 may be permanently affixed to the housing, may be semi-permanently affixed to the housing, or may be friction or slip-fitted onto the housing 802.

The clip 804 may be a flexible material, such as plastic, rubber or metal, configured to clip the wireless module 100 onto a headband (such as a large sized headband 302a or a small sized headband 302b) or other apparatus utilizing a friction hold, e.g., by way of flexing around the headband 300 to hold the clip fastener 800 in place.

In FIG. 17, the clip fastener 800 is shown fastening onto a small sized headband 302b; and in FIG. 18, the clip fastener 800 is shown fastening onto a large sized headband 302a. Together, these illustrations are intended to illustrate generally that the clip fastener 800 may be utilized to fasten a wireless module 100 onto a range of different headband sizes, or onto a range of sizes of whatever apparatus a user may wish to fasten the wireless module onto.

In the illustrations herein, particularly FIGS. 5, 6, 9, and 10, the set of headphones onto which the wireless module 100 is mounted include a female audio connector, such that a short cable having two male connectors may be coupled between the wireless module 100 and the headphones. However, in some examples, headphones may include a cable with a male headphone jack, which is configured to be plugged into a female audio cable connector, e.g., in an audio player or mobile device. Therefore, in a further aspect of the disclosure, a fastener and/or a wireless module 100 may include a suitable cable management apparatus, e.g., wherein the cable may be wrapped around the cable management apparatus and the male end of the cable may be plugged into the interface at the wireless module 100. In this way, whether the headphones include a female audio connector, or a cable with a male audio connector, either a short cable between two female audio connectors, or a neatly wrapped cable between the headphones and the Bluetooth module 100, may provide a more “wireless” user experience, wherein the headphones may be utilized without having a cable to interfere with the user's freedom of motion.

By utilizing any of the fasteners described above, within the scope of the present disclosure, a user may be enabled to utilize any conventional set of headphones as wireless headphones. Furthermore, a user may be enabled to utilize any desired audio playback apparatus, not limited to headphones but also including a car stereo, a home stereo, etc., as a wireless audio playback apparatus simply by fastening the disclosed wireless circuitry 100 to (or nearby) the audio playback apparatus and plugging in the audio cable interface as described.

In the foregoing specification, certain representative aspects of the invention have been described with reference to specific examples. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. An apparatus for providing wireless transmission of audio content, comprising:
a wireless module, comprising:
a wireless transceiver configured for receiving an audio stream;
an audio output interface configured for sending an audio output stream; and
a fastener for fastening the wireless module to an audio playback apparatus.

2. The apparatus of claim 1, wherein the fastener comprises a spring loaded grasping fastener, the grasping fastener comprising:
a grasping fastener housing having a ring located between and integrally attached to a pair of tubular members; and
a grasping arm having a friction grasping member secured to one or more rods configured to be movably received into the pair of tubular members.

3. The apparatus of claim 1, wherein the fastener comprises:
a metal plate adapted to be affixed to the audio playback device; and
one or more magnets affixed to the wireless module for securing the wireless module to the audio playback device by a magnetic force.

4. The apparatus of claim 3, wherein the metal plate includes a notch.

5. The apparatus of claim 1, wherein the fastener comprises:
one or more claws hingedly attached to a fastener housing configured to clamp onto the audio playback device.

6. The apparatus of claim 1, wherein the fastener comprises:
one or more clips secured to a fastener housing and configured to flex and clip onto the audio playback device.

7. The apparatus of claim 1, wherein the wireless module further comprises:
a bottom panel having an outer surface and an opposing inner surface, the wireless transceiver secured to the inner surface of the bottom panel;
an internal panel, in electrical communication with the wireless transceiver, the audio output interface secured to the internal panel; and
a housing adapted to receive the internal panel and the bottom panel, the bottom panel configured to form a bottom of the housing.

8. The apparatus of claim 7, wherein the wireless module further comprises:
a user interface, in electrical communication with the audio output interface, for enabling audio playback functionality, wherein the user interface comprises a plurality of buttons.

9. The apparatus of claim 8, wherein the user interface is located on an outer surface of the housing.

10. The apparatus of claim 9, wherein the user interface is a tactile switch.

11. The apparatus of claim 1, wherein the audio playback device is a set of headphones.

12. An apparatus for providing wireless transmission of audio content, comprising:
a wireless module, comprising:
a bottom panel having an outer surface and an opposing inner surface;
a wireless transceiver, secured to the inner surface of the bottom panel, configured for receiving an audio stream;
an internal panel, in electrical communication with the wireless transceiver, having an audio output interface configured for sending an audio output stream;
a housing adapted to receive the internal panel and the bottom panel, the bottom panel configured to form a bottom of the housing; and
a fastener for fastening the housing of the wireless module to an audio playback apparatus.

13. The apparatus of claim 12, wherein the fastener comprises a spring loaded grasping fastener, the grasping fastener comprising:
a grasping fastener housing having a ring located between and integrally attached to a pair of tubular members; and
a grasping arm having a friction grasping member secured to one or more rods configured to be movably received into the pair of tubular members.

14. The apparatus of claim 12, wherein the fastener comprises:
a metal plate adapted to be affixed to the audio playback device; and
one or more magnets affixed to the wireless module for securing the wireless module to the audio playback device by a magnetic force.

15. The apparatus of claim 14, wherein the metal plate includes a notch.

16. The apparatus of claim 12, wherein the fastener comprises:
one or more claws hingedly attached to a fastener housing configured to clamp onto the audio playback device.

17. The apparatus of claim 12, wherein the fastener comprises:
one or more clips secured to a fastener housing and configured to flex and clip onto the audio playback device.

18. The apparatus of claim 12, wherein the wireless module further comprises:
a user interface, in electrical communication with the audio output interface, for enabling audio playback functionality, wherein the user interface comprises a plurality of buttons.

19. The apparatus of claim 18, wherein the user interface is a rocker switch.

20. The apparatus of claim 12, wherein the audio playback device is a set of headphones.
